(19) United States
(12) Patent Application Publication
(10) Pub. No.: US 2013/0218299 A1
(43) Pub. Date: Aug. 22, 2013

(54) MCP Scheduling For Parallelization Of LAD/FBD Control Program In Multi-Core PLC

(71) Applicants: Ming Jie, Beijing (CN); Fei Long, Beijing (CN); Li Pan, Beijing (CN); Michael Wieczorek, Erlangen (DE)

(72) Inventors: Ming Jie, Beijing (CN); Fei Long, Beijing (CN); Li Pan, Beijing (CN); Michael Wieczorek, Erlangen (DE)

(73) Assignee: Siemens Aktiengesellschaft, Muechen (DE)

(21) Appl. No.: 13/820,702

(22) PCT Filed: Sep. 9, 2010
(86) PCT No.: PCT/CN2010/076623

§ 371 Date: Apr. 30, 2013

(51) Int. Cl. G05B 19/042

(52) U.S. Cl. CPC G05B 19/0421
USPC 700/4

(57) ABSTRACT

A compiler and method for parallelizing automatic control programs, wherein the method is applied to a Multi-Core Programmable Logic Controller (M-PLC) that includes multiple cores. The method includes the steps of dividing a serial automatic control program to be executed by the M-PLC into multiple program blocks, mapping the automatic control program to a parallelization model using the multiple program blocks, performing parallelization scheduling for the multiple program blocks according to the parallelization model to allocate respective multiple program blocks to the multiple cores of the M-PLC, converting each respective program block allocated to each core into respective machine codes, and downloading the machine codes to the multiple cores for their respective execution.

### CROSS-REFERENCE TO RELATED APPLICATIONS

This is a U.S. national stage of application No. PCT/CN2010/076623, filed on 3 Sep. 2010.

### BACKGROUND OF THE INVENTION

1. Field of the Invention

The present invention relates to the field of Automatic Control Systems and more particularly, to a method for parallelizing automatic control program applied to a Programmable Logic Controller (PLC) platform and a compiler for implementing the method.

2. Description of the Related Art

Automatic Control Systems are control systems that make production process or other processes run according to desired principles or predetermined programs without direct intervention from humans.

A Programmable Logic Controller (PLC) is a computer widely used in Automatic Control Systems, the hardware structure of which is basically the same as a microcomputer. In the PLC, is a Central Processing Unit (CPU) that is a controlling center. The PLC also has a compiler that which is used for converting a serial automatic control program (which is named as a control program for short hereinafter) edited in an engineering language into machine codes that are to be executed by the CPU, and thereby, the CPU is able to execute each instruction in the control program.

In order to improve system performance and processing capability of the PLC, the control program needs to be parallelized. For example, in a PLC with multiple CPUs, the multiple CPUs are used for executing the control program to be performed on the entire automatic control system in parallel, i.e., each CPU is responsible for executing one part of the control program. In addition, the compiler in the PLC is used for accomplishing scheduling for the control program besides converting the serial control program edited in an engineering language into machine codes, so that these machine codes can be executed on the multiple CPUs in parallel.

However, parallelization for the control program will increase computing complexity of the PLC. Therefore, it is an important issue in Automatic Control Systems techniques about how to realize a relatively satisfied parallelization for the control program with a relatively low computing complexity.

### SUMMARY OF THE INVENTION

Embodiments of the present invention provide a method for parallelizing automatic control programs, where the method is applied to a Multi-Core PLC (M-PLC) with multiple cores, and the method includes diving a serial automatic control program to be executed by the M-PLC into multiple program blocks, mapping the automatic control program to a parallelization model using the multiple program blocks, performing parallelization scheduling for the multiple program blocks according to the parallelization model to allocate the multiple program blocks to the multiple cores of the M-PLC respectively, and converting each program block allocated to each core into machine codes and downloading the machine codes to the multiple cores for their respective execution.

The embodiments of the present invention also provide a compiler for parallelizing automatic control programs, where the compiler is applied to an M-PLC with multiple cores, and the compiler includes a program dividing module, a parallelization model module, a parallelization scheduling module and a compiling module wherein the program dividing module is configured to divide a serial automatic control program to be executed by the M-PLC into multiple program blocks, the parallelization model module is configured to map the automatic control program to a parallelization model using the multiple program blocks which the program dividing module divides the automatic control program into, the parallelization scheduling module is configured to perform parallelization scheduling for the multiple program blocks according to the parallelization model, which the parallelization model module maps the automatic control program to, to allocate the multiple program blocks to the multiple cores of the M-PLC, and the compiling module is configured to convert each program block allocated to each core into machine codes and downloading the machine codes to the multiple cores for their respective execution according to a scheduling result of the parallelization scheduling module.

Accordingly, parallelization scheduling for the automatic control program based on the M-PLC can thus be realized by adopting the embodiments of the present invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The exemplary embodiments of the present invention will be described in detail hereinafter with accompany drawings to make those ordinarily skilled in this art understand the aforementioned and other features and advantages of the present invention more clearly, in which:

FIG. 1 is a flow chart of a method, for parallelizing automatic control programs according to an embodiment of the present invention;

FIG. 2 shows an example of a Program Dependency Graph (PDG);

FIG. 3 shows an example of a PDG as an input of parallelization scheduling;

FIG. 4 is a flow chart of a method for calculating the priority of each node in a PDG in an embodiment of the present invention;

FIG. 5 is a flow chart of a method for scheduling nodes in a PDG one by one according to the nodes' priorities in an embodiment of the present invention;

FIG. 6 is a diagram showing a compiler for implementing the method of the present invention according to an embodiment of the present invention;

FIG. 7 is a flow chart of a method for parallelizing automatic control programs according to an embodiment of the present invention; and

FIG. 8 shows an example of parallelization scheduling according to an embodiment of the present invention.

### DETAILED DESCRIPTION OF THE PREFERRED EMBODIMENTS

The present invention is further described in detail with the accompany drawings and embodiments hereinafter. It should be understand that the specific embodiments described herein are just for explaining, but not for limiting, the present invention.

The inventor of the present invention finds that a multi-core processor has become a developing trend in computing. The multi-core processor is a single processor (i.e., CPU) integrated with two or more than two complete computing engines (i.e., Core). Thus, it is possible to construct a PLC based on a platform of a multi-core processor in future automatic control systems, so as to achieve a higher processing capability and better system performance. Such a PLC can be called a Multi-core Programmable Logic Controller (M-PLC). However, if it is desired to fully utilize the processing capability of the multi-core processor in the PLC, the control program has to be parallelized so that the control program can be executed on multiple cores of the CPU in parallel. However, there is no such parallelization solution for the M-PLC that has been proposed till now.

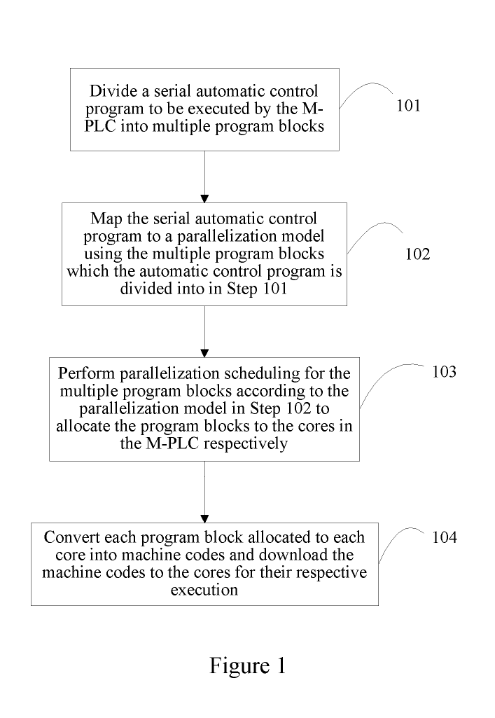

The embodiments of the present invention provide a method for parallelizing automatic control programs, and the method is applied to a platform based on the M-PLC and is performed by a compiler on the platform. FIG. 1 is a flow chart of the method for parallelizing automatic control programs according to an embodiment of the present invention. As shown in FIG. 1, the method includes:

Step 101: dividing a serial automatic control program to be executed by the M-PLC into multiple program blocks where, the automatic control program may be divided according to dependencies between instructions and, thus, one program block may include a group of instructions with highly restrictive dependencies.

In one embodiment of the present invention, when to divide an automatic control program based on Ladder Diagram (LAD) or Function Block Diagram (FBD), e.g., a S7-300/400 program or etc., a Network may be used as a dividing unit, i.e., the Network is taken as a parallelization granularity. This is because, for the LAD/FBD-based automatic control program, instructions in the same Network have relatively tight (or highly restrictive) dependencies.

Optionally, an instruction set smaller than the Network may be further used as a program block in certain cases. Specifically, one Network may include an inter-Network jump instruction (i.e., an instruction indicating a jump from the local Network to another Network), e.g., as shown in the following Table 1, the instruction “Ju M044; ” is an inter-Network jump instruction that indicates a jump from the local Network to another Network identified by “M044”. In this case, instructions from the first instruction to this inter-Network jump instruction of this Network may construct one program block and, meanwhile, instructions after this inter-Network jump instruction to the last instruction may construct another program block. Apparently, at this situation, the two program blocks both are smaller than the Network, and thus the parallelization granularity is smaller than the Network. Similarly, when a Network includes multiple inter-Network jump instructions, these inter-Network jump instructions can be taken as dividing points in dividing the automatic control program into program blocks. For example, a Network includes five instructions: instruction 1, instruction 2, instruction 3, instruction 4 and instruction 5, where instructions 2 and 4 are inter-Network jump instructions, and thus the control program of the Network is divided into three program blocks: a program block including instructions 1 and 2, a program block including instructions 3 and 4, and a program block including instruction 5.

TABLE 1

| NETWORK | | |
|---|---|---|
| TITLE = | | |
| A | M151.0; | |
| JC | M042; | |
| A | M152.0; | |
| JC | M043; | |
| JU | M044; | |
| ... | | |
| NETWORK | | |
| TITLE = | | |
| M044: L | | |
| | DB9.DBD | 80; // |

In addition, the Network may also include an intra-Network jump instruction. As shown in the following Table 2, the instruction “JNB 001; ” is an intra-Network jump instruction that indicates jumping to another instruction within the local Network. In such a case, the Network is still taken as a dividing unit, i.e., such a Network is divided as one program block.

TABLE 2

| NETWORK | | |
|---|---|---|
| TITLE = | | |
| A( | ; | |
| L | DB19.DBD | 28; |
| RNC | ; | |
| T | DB19.DBD | 32; |
| AN | OV; | |
| SAVE | ; | |
| CLR | ; | |
| A | BR; | |
| ) | ; | |
| JNB | _001; | |
| L | DB19.DBW | 34; |
| T | PQW | 134; |

| | |
|---|---|
| _001:NOP | 0; |

Based on the above definition for the program block, the method for dividing the LAD/FBD-based automatic control program into multiple program blocks specifically includes the following steps: scanning instructions in the automatic control program one by one; when scanning the first instruction in a Network, creating a program block and allocating the first instruction to the program block currently created; after that, whenever scanning an instruction, performing the following processes: if the instruction currently scanned is an inter-Network jump instruction and is not the last instruction in the Network, allocating the inter-Network jump instruction to the program block previously created and creating a new program block; if the instruction currently scanned is not an inter-Network jump instruction, allocating this instruction to the program block previously created; and, if the instruction currently scanned is the last instruction in the network, allocating the last instruction to the program block previously created and stopping allocating instructions to the program block previously created. Consequently, most of the instructions belonging to the same Network can be allocated to the same program block, where, if a Network has one or more inter-Network jump instructions, the one or more inter-Network jump instructions can be taken as dividing points to divide the instructions of the Network into two or more program blocks.

Step 102: mapping the serial automatic control program to a parallelization model using the multiple program blocks obtained by dividing the automatic control program in Step 101.

In the embodiment of the present invention, the parallelization model may include multiple nodes that respectively correspond to the multiple program blocks obtained in Step 101, where each node represents one program block, and the dependencies between nodes represents the dependencies between corresponding program blocks, e.g., data exchanges between program blocks, execution priorities and/or hardware constraints and etc.

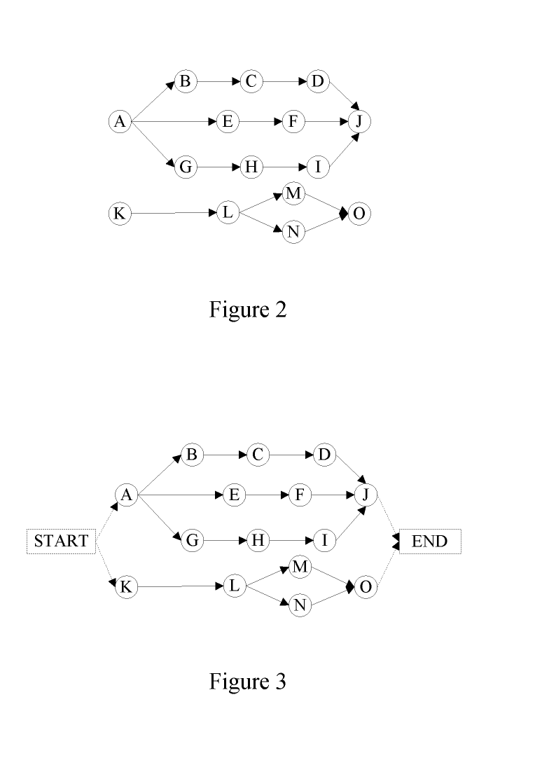

Specifically, the parallelization model may be a Program Dependency Graph (PDG) for the automatic control program. When the entire automatic control program has been divided into multiple program blocks, these program blocks will be analyzed according to the PDG, where each node represents one program block, and the connection between any two nodes represents the dependency between the two nodes. FIG. 2 is an example of a PDG. There are fifteen nodes including A to O in the PDG. As can be seen from FIG. 2, the PDG is a serial diagram, and thus the automatic control program can be presented as a serial diagram that is input to the compiler as the input of parallelization scheduling.

Step 103: performing parallelization scheduling for the multiple program blocks according to the parallelization model in Step 102, so as to allocate the program blocks respectively to the cores in the M-PLC.

In one embodiment of the present invention, the parallelization model is a PDG, and the method for performing parallelization scheduling for the multiple program blocks according to the PDG specifically includes three steps:

In the first step, a Critical Path of the PDG is searched out.

Specifically, for the convenience of analyzing, two virtual nodes, START and END, have to be added to the PDG at first. As shown in FIG. 3, virtual nodes, START and END, which are shown using dashed lines have been added to the PDG of FIG. 2. After adding the two virtual nodes, the Critical Path can be searched out. In a PDG, each node has its own weight that may be an execution cost of the program block corresponding to the node, and any two nodes connected with each other correspond to an execution cost between the two nodes. Herein, the Critical Path is referred to as the path with the longest length in the PDG, the length of a path may be referred to as the execution cost of the path, and thus the Critical Path may be referred to as the path with the largest execution cost, where, the length of the Critical Path may be named as CP_Length for short. In the embodiment of the present invention, the execution cost of the node may be taken as the weight of the node and, in this case, the Critical Path is the one in which the sum of the nodes' execution costs is the largest. Those skilled in this art can understand that the execution cost of the node may be a time cost, and thus the execution cost of the node may be used to denote the time required to execute the control program corresponding to the node. Referring to FIG. 3, under the assumption that the path A-G-H-I-J has the largest sum of execution costs, this path A-G-H-I-J is determined as the Critical Path. Based on the above definitions for the Critical Path and the length of the path, various existing searching algorithms can be used to search the Critical Path, the specific implementation of which will not be described herein.

In the second step, priorities of all the nodes in the PDG are calculated according to the Critical Path searched out.

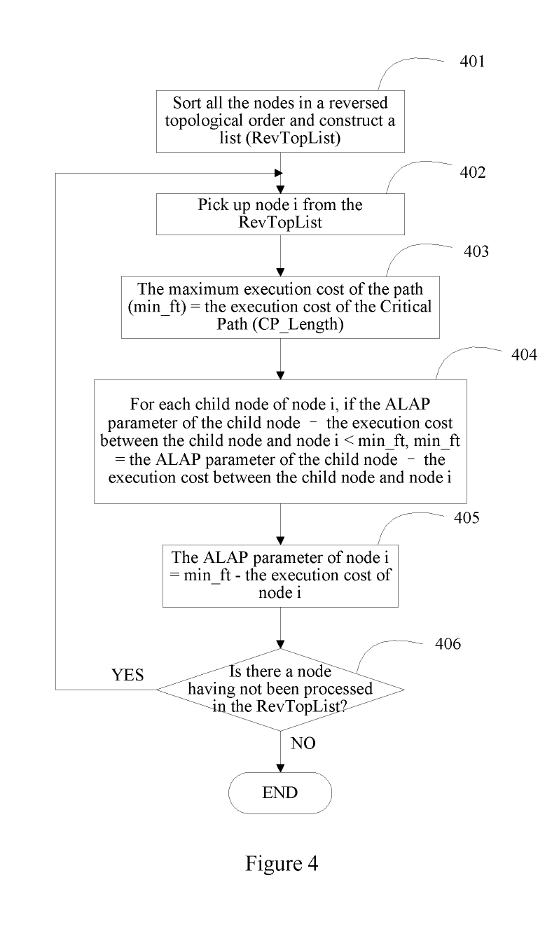

In one embodiment of the present invention, a parameter, As Late As Possible (ALAP), is used to represent the priority of the node. The ALAP parameter can be calculated according to the CP_Length, where the CP_Length is the execution cost of the Critical Path. The specific method for calculating the ALAP parameter of each node will not be described in detail herein, and will be discussed subsequently with respect to FIG. 4. Those skilled in the art can understand that, the ALAP parameter is a time parameter that denotes the latest time for execution and, thus, the ALAP parameter of one node can be used to denote the latest time for executing the control program corresponding to the node.

In the third step, the nodes of the PDG are scheduled one by one according to the priority of each node calculated in the second step, so that the nodes are allocated to each core in the M-PLC one by one, and thereby the program blocks corresponding to the nodes are allocated respectively to the cores for their execution.

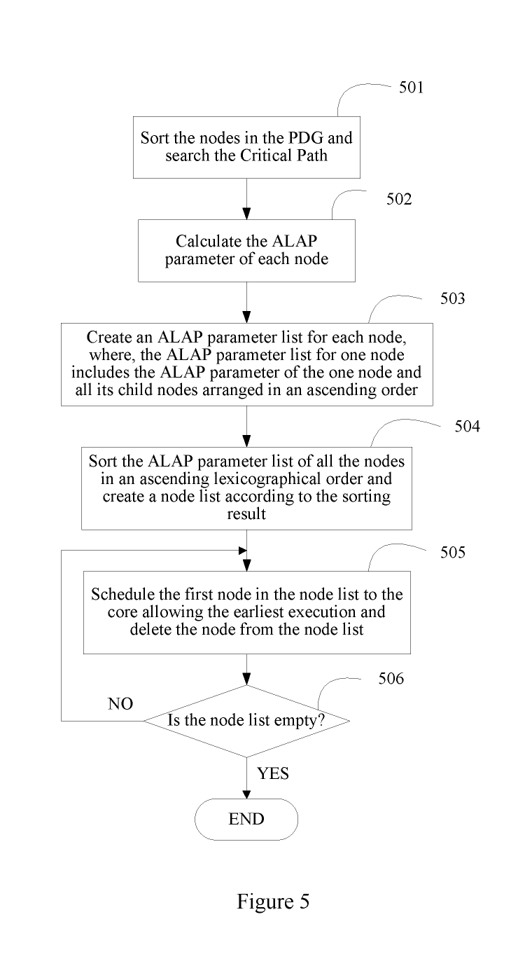

In one embodiment of the present invention, the ALAP parameter is used to denote the priority of the node and, thus, the nodes can be scheduled one by one in this step according to the ALAP parameter of each node calculated in the second step. The specific method for scheduling each node according the ALAP parameter will not be described in detail herein, and will be discussed subsequently with respect to FIG. 5.

Furthermore, after allocating the program blocks respectively to the cores, an instruction for synchronization communication needs to be added to some program blocks (which is named as to add synchronization communication for short). For example, program block 1 is allocated to core 1, program block 2 is allocated to core 2, and program blocks 1 and 2 have a dependency relationship, and in this case, the instruction for synchronization communication between program blocks 1 and 2 needs to be added between cores 1 and 2.

In one embodiment of the present invention, the PDG is used as the parallelization model, and when performing parallelization scheduling for each program block, the nodes in the PDG that respectively represent the program blocks are respectively allocated to the cores. Meanwhile, whether to add synchronization communication between cores and which nodes the synchronization communication should be added to are further determined considering the dependencies between the nodes. Specifically, when allocating to a certain core one or more nodes corresponding to a process/thread (which is also called an available part), with regard to each node, it is determined whether all the precursors of this node have been allocated to this core, where if it is determined that all the precursors of this node have been allocated to this core, no synchronization communication is to be added, and otherwise, the core of each precursor that is not allocated to this local core is determined and the synchronization communication between the node and each precursor that is not allocated to the same core as the node is added, thus the synchronization communication between the cores is added. Here, when adding the synchronization communication between two nodes, the need exists to insert the instructions for the synchronization communication to the program blocks corresponding to the two nodes. Here, the existing solution may be adopted to add the synchronization communication between cores in the embodiment of the present invention, where the compiler can automatically generate codes of the instruction for synchronization communication between the cores, the specific implementation of which will not be discussed in this paper.

Step 104: converting each program block respectively allocated to each core into machine codes, and downloading the machine codes to the cores for their respective execution.

Optionally, before performing Step 104, the automatic control program edited in an engineering language is translated to the one in a common language format and, thus, when converting the program blocks into the machine codes in Step 104, the compiler of the common language is directly called to compile the automatic control program to be executed by each core. Specifically, in the above solution, each program block obtained by dividing the whole automatic control program in Step 101 and each program block allocated to each core after the parallelization scheduling performed in Step 103 all correspond to a program edited in an engineering language, and in the embodiment of the present invention, the program block corresponding to each core may be translated to the one in a common language format after performing Step 103. In this case, the compiler will edit the codes for the synchronization communication in the common language format when adding the synchronization communication between cores.

Considering that C language is the most popular common programming language at present, and there exist various mature compilers of C language for different hardware platforms. Therefore, C language can be taken as a conversion medium between the engineering language and the machine codes in the embodiment of the present invention. Specifically, after Step 103, an execution queue of each core (i.e., the program block(s) corresponding to each core) is translated into codes edited in C language, and in this case, the synchronization communication added in Step 103 by the compiler is also in codes edited in C language. At this point, the compiler will directly call the compiler of C language to convert the execution queue of each core into machine codes.

FIG. 4 is a flow chart of a method for calculating the priority of each node in the PDG in an embodiment of the present invention. In this embodiment, the ALAP parameter is taken as the priority of the node. As shown in FIG. 4, the method includes the following steps:

Step 401: sorting all the nodes in the PDG in a reversed topological order, and constructing a list, RevTopList. Here, a depth-first algorithm may be used to traverse each node in the PDG, whenever traversing a node, the node is added to the RevTopList which may be a first-in-first-out queue, and thus a list of nodes in a reversed topological order is formed. Those skilled in this art can understand that various existing methods can be used to implement this step specifically, which will not be discussed further.

Step 402: picking up a node i from the RevTopList.

Step 403: the maximum execution cost for a path (min_{—} ft)=the length of the Critical Path (CP Length). Here, min_{—} ft represents the maximum execution cost for the path taking the current node as the endpoint in the PDG, and the length of the Critical Path denoted by CP_Length is the execution cost of the Critical Path.

Step 404: if node i has a child node, and for each child node of node i, performing the following process: if the ALAP parameter of the child node−the execution cost between the child node and node i<min_ft, and then, min_ft=the ALAP parameter of the child node−the execution cost between the child node and node i.

Step 405: the ALAP parameter of node i=min_ft−the execution cost of node i.

Step 406: determining whether there is an exemplary node having not been processed, if it is determined that there is, returning to Step 402, and otherwise, ending this flow.

Specifically, Table 3 below shows exemplary Pseudo Code for calculating the ALAP parameter of each node in the PDG according to the above method. In Table 3, min_ft is the maximum execution cost of a path, alap(ni) and alap(ny) are respectively the ALAP parameters of nodes ni and ny, w(ni) is the weight (i.e., the execution cost) of node ni, and c(ni,ny) is the execution cost between nodes ni and ny.

```
TABLE 3
Construct a list of nodes in reversed topological order. Call it RevTopList.
for each node ni in RevTopList do
  min_ft = CP Length
  for each child ny of ni.do
    if alap(ny)− c(ni, ny) < min_ft then
      min_ft = alap(ny)− c(ni, ny)
    endif
  endfor
  alap(ni) = min_ft − w(ni)
endfor
```

FIG. 5 is a flow chart of a method for scheduling nodes in a PDG one by one according to the nodes' priorities in an embodiment of the present invention. In the presently contemplated embodiment, the ALAP parameter is used as the priority of the node. As shown in FIG. 5, the method includes the following steps:

Step 501: sorting each node in the PDG and searching the Critical Path.

Step 502: calculating the ALAP parameter of each node.

In the above Steps 501 and 502, the ALAP parameter of each node may be calculated after the nodes have been sorted in a reversed topological order, and the specific process of Steps 501 and 502 has been described in detail before, which will not be discussed here.

Step 503: creating an ALAP parameter list for each node, where the ALAP parameter list of one node includes the ALAP parameter(s) of this node and all the child node(s) of this node in an ascending order. Those skilled in this art can understand that according to the character of the ALAP parameter, the ALAP parameter of one node is definitely smaller than that of its child node. And thus, in the ALAP parameter list of one node, the ALAP parameter of this node will be listed in the first place, and after this node's ALAP parameter, the ALAP parameter(s) of the child node(s) is/are listed in an ascending order. Here, the ALAP parameter list may be realized as a first-in-first-out queue.

Step 504: sorting the ALAP parameter lists of all the nodes in Step 503 in an ascending lexicographical order, and creating a node list according to the sorting result.

Those skilled in this art can understand that, each ALAP parameter list created in Step 503 includes one or more ALAP parameters in an ascending order and, thus, when sorting these ALAP parameter lists in the ascending lexicographical order, the first ALAP parameters respectively in these ALAP parameter lists are compared at first, for any two ALAP parameter list., if their first ALAP parameters are different, the ALAP parameter list with the smaller ALAP parameter is put to, the front, and if their first ALAP parameters are the same, their next ALAP parameters will be compared according to the same principle until the comparing result is that the two ALAP parameters are the same or their last ALAP parameters have been compared. Here, the existing solution can be adopted to sort the multiple ALAP parameter lists in the lexicographical order, which will not be described here.

Specifically, when creating the node list according to the sorting result, the node list lists the nodes respectively corresponding to the ALAP parameter lists in the ascending lexicographical order, and the node list may include information of each node corresponding to the ALAP parameter lists being sorted. For example, supposing there are three nodes: node 1, node 2 and node 3, the ALAP parameter lists created for the three nodes are respectively list 1, list 2 and list 3, and after sorting the three ALAP parameter lists in the lexicographical order, the sorting result is: list 3, list 1 and list 2, and a node list can be created according to this sorting result where information of the three nodes included therein are in such an order: information of node 3, information of node 1 and information of node 2.

Step 505: Scheduling the first node listed in the node list to the core allowing the earliest execution, and then deleting this node from the node list. Here, the existing solution can be used to determine the core allowing the earliest execution, which will not be discussed.

Step 506: determining whether the node list is empty, if it is determined that it is empty, ending this flow, and otherwise, returning to Step 505.

Specifically, when scheduling the nodes in the node list to the cores one-by-one, a first-in-first-out execution queue can be created for each core, where the information of each node scheduled to the node is in a certain order, and when scheduling one node to a certain core, an insertion approach may be used to insert the information of this node to the execution queue of this core. After the scheduling, the compiler is able to determine each program block scheduled to each core according to the information of the nodes contained in these execution queues.

From the aforementioned flows, it can be understood that during the parallelization scheduling of the embodiment of the present invention, not only the priority (e.g., ALAP parameter) of a single node in the PDG is considered, but also the priority of each child node can be further considered and, thus, in case there are two nodes with the same priority, the priorities of their child nodes can be compared iteratively, so as to basically avoid competition problems among nodes with the same priority. Compared with the existing scheduling algorithm, the parallelization scheduling method of the embodiment of the present invention can schedule a node to a more appropriate time slot with relatively low computing complexity. Supposing the number of the nodes in the PDG is v, the computing complexity in the parallelization scheduling method of the embodiment of the present invention is O(v² log v).

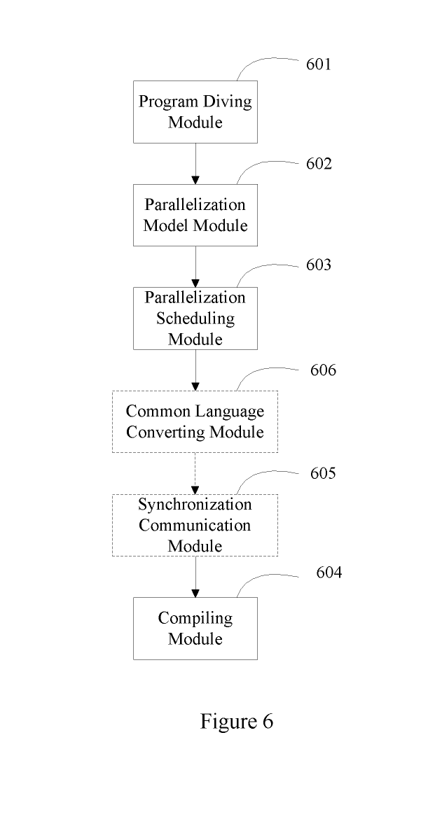

Based on the method for parallelizing the automatic control program provided by the aforementioned embodiments of the present invention, the embodiments of the present invention further provides a compiler for performing such method. FIG. 6 is a diagram showing a compiler for implementing the method of the present invention according to an embodiment of the present invention. As shown in FIG. 6, the compiler includes the following components:

A program dividing module 601 is configured to divide a serial automatic control program to be executed by the M-PLC into multiple program blocks.

A parallelization model module 602 is configured to map the serial automatic control program to a parallelization model using the multiple program blocks which the program dividing module 601 divides the automatic control program into.

A parallelization scheduling module 603 is configured to perform parallelization scheduling for the multiple program blocks according to the parallelization model, which the parallelization model module 602 maps the automatic control program to, to allocate the multiple program blocks to the cores of the M-PLC respectively.

A compiling module 604 is configured to convert each program block allocated to each core into machine codes and downloads the machine codes to the cores for their respective execution according to a scheduling result of the parallelization scheduling module 603.

The compiler may further include a synchronization communication module 605, and the synchronization communication module 605 connects with the parallelization scheduling module 603 and configured to add synchronization communication between the cores in the M-PLC according to the scheduling result of the parallelization scheduling module 603, i.e., add one or more instructions for synchronization communication between one or more cores in the corresponding one or more program blocks of the one or more cores.

The compiling module 604 may have compiling functions for only common languages, and in this case, the compiler may further include a common language converting module 606 which is configured to convert the automatic control program edited in an engineering language to the one in a common language format, so that the compiling module 604 can convert the automatic control program in the common language format to machine codes for each core's execution in the CPU. Specifically, the common language converting module 606 may connect the parallelization scheduling module 603, and is adapted for translating the program block corresponding to each core into the one in the common language format according to the scheduling result of the parallelization scheduling module 603. Further, when the compiler includes the synchronization communication module 605, the common language converting module 606 is connected between the parallelization scheduling module 603 and the synchronization communication module 605, where, the common language converting module 606 is configured to convert the program block of each core edited in the engineering language to the one in the common language format according to the scheduling result of the parallelization scheduling module 603, outputting to the synchronization communication module 605 the program block of each core having been converted to the one in the common language format, and the synchronization communication module 605 is configured to add directly to the program blocks of the cores the instruction(s) for synchronization communication in the common language format, and output to the compiling module 604 the program block of each core in the common language format.

The specific implementation for the functions of the aforementioned modules has been described in detail in the aforementioned embodiments of the present invention, which will not be discussed herein.

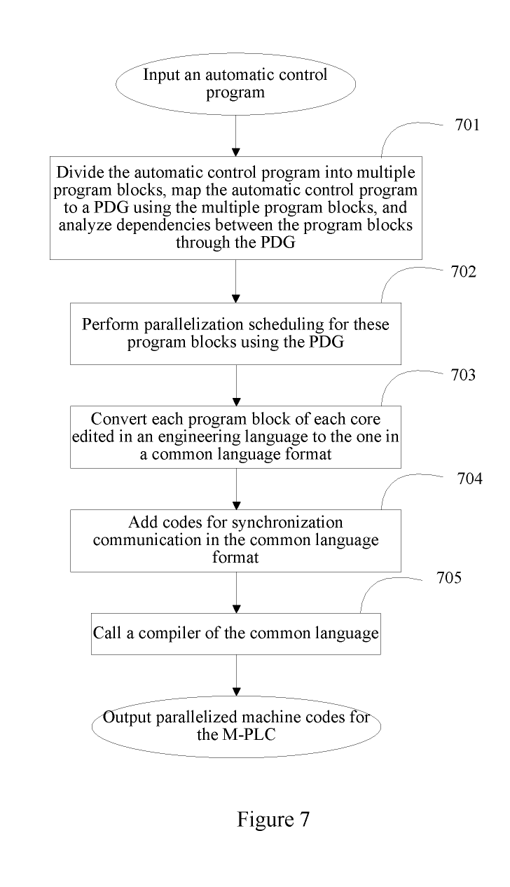

Based on the functions and structure of the compiler shown in FIG. 6, a method for parallelizing automatic control programs adopting this compiler is as shown in FIG. 7, and the method includes the following steps:

Step 701: inputting the automatic control program to be executed by the M-PLC, dividing the automatic control program into multiple program blocks, mapping the automatic control program to a PDG using these program blocks, and through the PDG, the dependencies among these program blocks can be analyzed. Here, each program block is no more than a Network for the automatic control program based on LAD/FBD.

Step 702: performing parallelization scheduling for these program block using the PDG

Step 703: converting the program block of each core edited in an engineering language to the one in a common language format.

Step 704: adding codes in the common language format for the instructions for synchronization communication between the cores. Step 705: calling a compiler of the common language to convert the program codes in the common language format to machine codes parallelized for the M-PLC.

The specific implementation for the aforementioned steps has been described m detail before, which will not be discussed here.

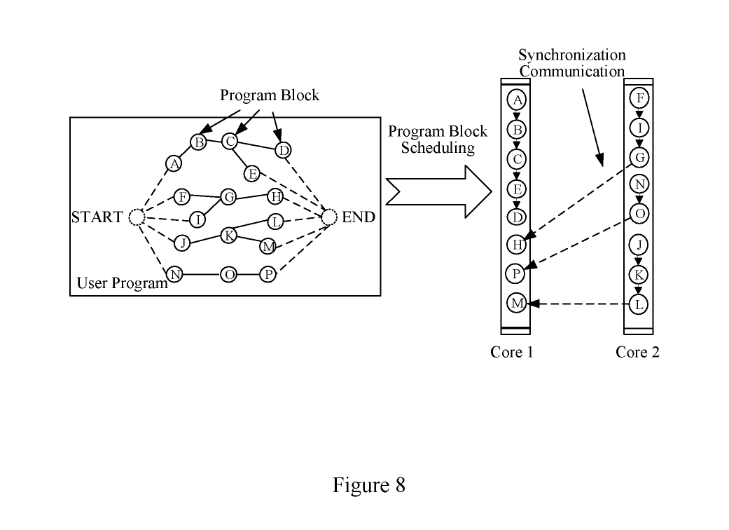

FIG. 8 shows an example of parallelization scheduling according to an embodiment of the present invention. In FIG. 8, a user program is scheduled in parallel to two cores of a single CPU, cores 1 and 2. At first, the user program is divided into multiple program blocks and is mapped to a PDG, where the nodes in the PDG respectively correspond to the multiple program blocks. Next, these program blocks are scheduled in parallel to cores 1 and 2 according to the dependencies between the program blocks presented by the PDG. And further, three synchronization communications are added between cores 1 and 2 according to the dependencies between the program blocks.

To test the technical effects of the parallelization solution proposed by the embodiments of the present invention, a test example is given below. The test example is with regard to an LAD/FBD-based control program on a PLC platform having an Intel 2.9 GHz CPU and a 4G Memory, where the CPU has double cores, and the parallelization scheduling algorithm is implemented in C# language. Table 4 below lists five test results, where, the parallelization degree is evaluated by two measurement values usually used in parallel computing area, including: Speedup and Degree of Concurrency (DoC). It can be seen from Table 4 as follows that when DoC is more than the number of the cores (i.e., 2), the Speedup is almost equal to 2, and that is, the speed is increased almost by twice. This means that the parallelization solution provided by the embodiments of the present invention can fully utilize the resources of the double cores of the CPU, and significantly raises the system performance and processing capability of the PLC platform.

TABLE 4

| | DoC | Speedup |
|---|---|---|
| Test 1 | 2.515 | 1.997 |
| Test 2 | 1.229 | 1.213 |
| Test 3 | 5.193 | 1.999 |
| Test 4 | 1.389 | 1.389 |
| Test 5 | 1.346 | 1.345 |

It can be understood from the aforementioned embodiments of the present invention that, regarding the automatic control program based on LAD/BFD, the parallelization granularity no more than a Network is adopted so as to fully utilize the multi-core resources of the M-PLC, and a static scheduling mechanism is also adopted, which introduces relatively low computing complexity. The embodiments of the present invention can effectively convert the serial automatic control program edited in the engineering language to parallel codes that can be executed on the multiple cores of the CPU simultaneously, which thereby shortens the executing time of the automatic control program a lot and significantly raises the system performance and processing capability of the M-PLC.

The foregoing is only preferred embodiments of the present invention, however, is not used to limit the present invention. Any modification, change or substitution, without departing from the spirit and principle of the present invention, should be covered by the protection scope of the present invention.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A method for parallelizing automatic control programs for application to a Multi-Core Programmable Logic Controller (M-PLC) including multiple cores, the method comprising the steps of:
dividing, in a processor of the M-PLC, a serial automatic control program to be executed by the M-PLC into multiple program blocks;
mapping, by the processor of the M-PLC, the automatic control program to a parallelization model using the multiple program blocks;
performing parallelization scheduling for the multiple program blocks according to the parallelization model to allocate respective multiple program blocks to the multiple cores of the M-PLC; and
converting each program block allocated to each core of the M-PLC into respective machine codes, and downloading the machine codes to the multiple cores for their respective execution.

19. The method of claim 18, wherein the automatic control program comprises multiple instructions, wherein the automatic control program is divided into the multiple program blocks according to dependencies between the multiple instructions; and wherein one program block comprises a group of instructions with highly restrictive dependencies.

20. The method of claim 19, wherein, when the automatic control program is based on one of Ladder Diagram (LAD) and Function Block Diagram (FBD), the automatic control program comprises one or more Networks; and wherein said one program block comprises one of a Network or an instruction set smaller than the Network.

21. The method of claim 20, wherein said dividing a serial automatic control program to be executed by the M-PLC into multiple program blocks comprises: scanning the multiple instructions of the automatic control program one-by-one, and, when scanning an instruction, performing the following steps of:
creating a program block and allocating the instruction currently scanned to the program block currently created if the instruction currently scanned is a first instruction in a Network;
creating a new program block if the instruction currently scanned is an inter-Network jump instruction;
allocating the instruction currently scanned to the program block previously created if the instruction currently scanned is not the first instruction in the Network; and
creating a new program block if the instruction currently scanned is the inter-Network jump instruction and is not a last instruction in a local Network.

22. The method of claim 18, wherein the parallelization model comprises multiple nodes and dependencies between the multiple nodes; wherein the multiple nodes respectively represent the multiple program blocks; and wherein the dependencies between the multiple nodes represent dependencies between corresponding program blocks.

23. The method of claim 22, wherein the parallelization model is a Program Dependency Graph; and wherein each node has a weight, the weight of one node being an execution cost of a program block corresponding to the node, and any two nodes connected with each other correspond to an execution cost between the two nodes.

24. The method of claim 23, wherein said performing parallelization scheduling for the multiple program blocks according to the parallelization model comprises: searching a Critical Path in the PDG and calculating priorities of all nodes in the PDG according to the weight of each node and the execution cost between each two nodes connected with each other;
and scheduling nodes in the PDG one-by-one according to the priorities and allocating the nodes to the cores one-by-one to respectively allocate the program blocks corresponding to the nodes to the cores.

25. The method of claim 24, wherein the priority is an As Late As Possible (ALAP) parameter, and said calculating priorities of all the nodes comprises: sorting all the nodes in the PDG in a reversed topological order; and, for each node in turn, performing the following process: min ft=CP Length, wherein said min_ft denotes a maximum execution cost of a path taking a current node as an endpoint, said CP Length denotes an execution cost of a Critical Path; if the current node has a child node, and for each child node of the current node, performing: if alap(ny)−c(ni,ny)<min_ft, and min_ft=alap(ny)−c(ni,ny); wherein said alap(ny) denotes an ALAP parameter of a child node, and said c(ni,ny) denotes an execution cost between the child node and the current node; and alap(ni)=min_ft−w(ni); and wherein said alap(ni) denotes an ALAP parameter of the current node, and said w(ni) denotes an execution cost of the current node.

26. The method of claim 24, wherein the priority is an As Late As Possible (ALAP) parameter, and said scheduling the nodes in the PDG one-by-one according to the priorities and allocating the nodes to the cores one-by-one comprises: a) creating an ALAP parameter list for each node, wherein the ALAP parameter list of a node comprises: the ALAP parameters of the node and all child nodes of the node in an ascending order; b) sorting the ALAP parameter lists of all the nodes in an ascending lexicographical order and creating a node list according to a result of said sorting, wherein, the node list lists the nodes respectively corresponding to the ALAP parameter lists in the ascending lexicographical order; c) scheduling a first node listed in the node list to a core allowing an earliest execution, and deleting the first node from the node list; and d) continuing to perform step c if the node list is not empty.

27. The method of claim 18, wherein after said performing parallelization scheduling for the multiple program blocks, the method further comprises the step of: adding at least one instruction for synchronization communication in at least one program block of at least one core according to a result of said scheduling and dependencies between the program blocks.

28. The method of claim 27, wherein, when the parallelization model is a PDG, said adding at least one instruction for synchronization communication in at least one program block of at least one core according to a result of said scheduling and dependencies between the program blocks comprises: when allocating a node to a core, determining whether all precursors of the node have been allocated to the core;
wherein if it is determined that all the precursors of the node have been allocated to the core, no instructions for synchronization communication is to be added; and otherwise, determining cores which the precursors, having not been allocated to the core, have been allocated to, and adding in corresponding at least one program block at least one instructions for synchronization communication between the node and the precursors having not been allocated to the one core.

29. The method of claim 18, wherein before said converting each program block allocated to each core into machine codes respectively, the method further comprises the step of:
converting each program block allocated to each core which is edited in an engineering language into one in a common language format; and
said converting each program block allocated to each core into machine codes respectively comprises the step of:
converting each program block allocated to each core which has been converted into the one in the common language format into machine codes.

30. The method of claim 29, wherein, the common language format is C program language.

31. A compiler for parallelizing automatic control programs which is applied to a Multi-Core Programmable Logic Controller (M-PLC) including multiple cores, the compiler comprising:
a program dividing module;
a parallelization model module;
a parallelization scheduling module; and
a compiling module;
wherein the program dividing module is configured to divide a serial automatic control program to be executed by the M-PLC into multiple program blocks;
wherein the parallelization model module is configured to map the automatic control program to a parallelization model using the multiple program blocks which the program dividing module divides the automatic control program into;
wherein the parallelization scheduling module is configured to perform parallelization scheduling for the multiple program blocks according to the parallelization model, which the parallelization model module maps the automatic control program to, to allocate the multiple program blocks to the multiple cores of the M-PLC, respectively; and
wherein the compiling module is configured to convert each program block allocated to each core into machine codes and download the machine codes to the multiple cores for their respective execution according to a scheduling result of the parallelization scheduling module.

32. The compiler of claim 31, further comprising:
a synchronization communication module configured to add at least one instruction for synchronization communication in at least one program block of at least one core according the scheduling result of the parallelization scheduling module and dependencies between the program blocks presented in the parallelization model.

33. The compiler of claim 31, further comprising:
a common language converting module configured to convert each program block allocated to each core which is edited in an engineering language into a common language format according to the scheduling result of the parallelization scheduling module, and configured to output to the compiling module each program block allocated to each core which has been converted into the common language format;
wherein the compiling module is further configured to convert each program block allocated to each core which has been converted into the common language format into machine codes.

34. The compiler of claim 32, further comprising:
a common language converting module configured to convert each program block allocated to each core which is edited in an engineering language into a common language format according to the scheduling result of the parallelization scheduling module, and output to the synchronization communication module each program block allocated to each core which has been converted into the common language format;
wherein the at least one instruction for synchronization communication added by the synchronization communication module are in the common language format; and
wherein the synchronization communication module is further configured to output to the compiling module each program block allocated to each core in the common language format with the at least one instruction for synchronization communication being added; and wherein the compiling module is further configured to convert each program block allocated to each core in the common language format into machine codes.
